(19) United States
(12) Patent Application Publication
(10) Pub. No.: US 2026/0252058 A1
(43) Pub. Date: Aug. 27, 2026

(54) SENSORLESS FEED OPTIMIZATION

(71) Applicant: FANUC CORPORATION, Yamanashi (JP)

(72) Inventors: Yen Po Liu, Union City, CA (US); Tetsuaki Kato, Union City, CA (US)

(21) Appl. No.: 19/063,586

(22) Filed: Feb. 26, 2025

(51) Int. Cl. G05B 19/416

(52) U.S. Cl. CPC G05B 19/4163; G05B 2219/43182; G05B 2219/49108

(57) ABSTRACT

A sensorless method for cutting tool feed speed optimization which computes a feed speed profile where the feed speed is increased at locations in the machining cycle where spindle torque is below a target value. Time-series data is recorded, including position and spindle torque command value, for a reference machining cycle. A spindle torque command target is determined either as a maximum value from the reference machining cycle or based on machine limits. An optimum feed speed profile is computed where, at the tool position for each time step, a new feed speed is determined by multiplying the original feed speed by a ratio of the spindle torque command target to the recorded spindle torque in the reference machining cycle. The optimum feed speed profile is used by a controller in production machining operations. Feedback control may be used in the controller along with the optimum feed speed profile.

### BACKGROUND

### Field

The present disclosure relates generally to the field of cutting tool feed speed control and, more particularly, to a method for feed speed optimization which collects spindle torque command data for many location points in a reference machining cycle, and computes an optimized feed speed profile in which the feed speed is increased at locations in the machining cycle where spindle torque is below a target value, and vice versa.

### Discussion of the Related Art

It is known in the art to use computer-controlled devices to perform machining operations, such as drilling and milling, on parts. In some applications, computer numerical controlled (CNC) machines are used which move a tool along three principle directions, with or without changes in the tool's orientation. In other applications, a multi-axis industrial robot is fitted with a machining head, and the robot can move the tool along any arbitrary spatial path while also controlling the tool orientation to any desired value.

Regardless of what type of machine tool or robot is used to perform the machining operation, the quality of the finished workpiece is always important, and conditions which may be detrimental to the workpiece quality or the longevity of the machine tool must be avoided. At the same time, machine productivity is also extremely important to manufacturers, who must provide cost-competitive products. Thus, the feed speed of the cutting tool must be defined in a manner which meets both quality and productivity objectives.

In a typical machining operation, the path of a cutting tool as it cuts material from a workpiece is defined in a control program. In many machining operations, the shape of the raw workpiece and/or the finished workpiece is such that the amount of material cut by the cutting tool varies as the tool moves along the tool path. In order to avoid damage to the machine tool or the workpiece, the user may reference a cutting tool catalog to select the appropriate tool feed speed for the tool path based on the depth of cut and the type of workpiece material.

In traditional machine control programs, a constant feed speed is specified throughout the machining operation which prevents the maximum chip load (and therefore, spindle torque) from exceeding an acceptable level. Although the constant feed speed technique is easy to program, the technique is also inefficient since material removed by the cutter varies along the toolpath. This means the cutting speed could be increased at many points along the tool path to reduce the cycle time while still maintaining acceptable chip load.

Techniques are known in the art for cutting tool feed speed improvement, but these techniques all have certain drawbacks and limitations. One known technique involves the use of simulators, where three-dimensional models of the workpiece and the machining operation are used to estimate the volume of workpiece material being cut at all locations along the programmed tool path, and the cut volume is used to compute a feed speed at points along the tool path. However, these machining operation simulator systems are expensive, and simulation of small-scale machining can be very time-consuming.

Yet another known tool feed speed improvement technique uses online feedback control, tuning feed speed in real time to maintain consistent cutting torque. Feedback control of feed speed can be effective in some applications, but some overshoot of the target torque value may be unavoidable due to the nature of feedback control. In addition, tuning of the parameters of a proportional-integral-derivative (PID) controller can be unintuitive because the machining process is typically time-varying.

In view of the circumstances described above, there is a need for an improved cutting feed speed optimization method which does not require simulation software, and which can accurately compute a feed speed profile which meets both load management and cycle time requirements in machining operations.

### SUMMARY

The present disclosure describes a method for cutting tool feed speed optimization which collects spindle torque command data for a reference machining cycle, and computes an optimized feed speed profile in which the feed speed is increased at locations in the machining cycle where spindle torque is below a target value. Time-series data is recorded, including a tool center point position and a corresponding spindle torque command value, for many time steps of the reference machining cycle. A spindle torque command target value is determined either as a maximum spindle torque command value from the reference machining cycle or based on machine mechanical limits. A new optimum feed speed profile is then computed where, at the tool center point position for each time step, a new feed speed is determined by multiplying the original feed speed by a ratio of the spindle torque command target value to the recorded spindle torque for the time step in the reference machining cycle. The optimum feed speed profile is used by a machine controller in production machining operations. Feedback control may be incorporated into the controller for real-time adjustment of feed speed based on actual spindle torque.

Additional features of the presently disclosed systems and methods will become apparent from the following description and appended claims, taken in conjunction with the accompanying drawings.

### BRIEF DESCRIPTION OF THE DRAWINGS

FIG. 1 is a schematic illustration of a system including a computer-controlled machine tool performing a machining operation on a workpiece, of a type applicable to the techniques of the present disclosure;

FIG. 2A is an illustration of a machine tool cutting operation where the tool moves at a constant feed speed using a conventional programming technique, and FIG. 2B is an illustration of a machine tool cutting operation where the tool moves at a feed speed which is varied based on an amount of material being removed according to an embodiment of the present disclosure;

FIG. 3 includes a graph of spindle torque versus time and a graph of feed speed versus time, each graph including a data trace for a conventional constant feed speed and a data trace where the feed speed is varied based on the amount of material being removed according to an embodiment of the present disclosure;

FIG. 4 is a block diagram of a system for sensorless feed speed optimization with supplemental feedback control, including providing a reference feed speed from an optimized feed speed profile and adjusting the reference feed speed using feedback control, according to an embodiment of the present disclosure;

FIG. 5 is a flowchart diagram of a method for sensorless feed speed optimization, including calculation of an optimum feed speed profile based on spindle torque data from a reference machining cycle, according to an embodiment of the present disclosure;

FIG. 6 is a plan view illustration of a machine tool feed angle workspace in a sensor-based feed speed optimization implementation, where a plurality of sectors are defined, and a target value is selected at each time step based on which sector the tool feed angle vector falls within, according to an embodiment of the present disclosure;

FIG. 7 is a flowchart diagram of a method for sensor-based feed speed optimization, including calculation of an optimum feed speed profile based on axial acceleration data from a reference machining cycle, according to an embodiment of the present disclosure;

FIG. 8 is an illustration of a machining operation, depicting how tool motion creates a scalloped shape on a surface of a workpiece, provided to shown concepts used in the surface roughness prediction techniques of the present disclosure;

FIG. 9 is an illustration of an ideal cutting tool with a perfect shape and a real-world cutting tool with runout, depicting how tool runout affects the scalloped shape of the workpiece after machining and how this effect can be simulated in embodiments of the present disclosure;

FIG. 10 is an illustration of a path of a tip of a flute of a cutting tool in a plane of motion and a corresponding surface profile, depicting how workpiece surface roughness is simulated in embodiments of the present disclosure;

FIG. 11 is a flowchart diagram of a method for calculating a machining feed speed profile, including first performing a sensorless or sensor-based feed speed optimization, followed by an evaluation of surface roughness and adjustment of the feed speed profile if necessary, according to an embodiment of the present disclosure;

FIG. 12 is an illustration of a graphical user interface (GUI) screen of a software application configured for performing feed speed optimization of a machining operation, according to embodiments of the present disclosure;

FIG. 13 is an illustration of the graphical user interface (GUI) screen of FIG. 12, after the feed speed optimization computation has been performed, according to embodiments of the present disclosure;

FIG. 14 is an illustration of a workpiece to be machined by a tool path defined by a program containing command lines with a sparse control point spacing, and the workpiece with the tool path redefined with increased control point density, according to embodiments of the present disclosure; and

FIG. 15 is an illustration of a GUI screen of a software application configured for performing feed speed optimization and surface roughness prediction for a machining operation, according to embodiments of the present disclosure.

### DETAILED DESCRIPTION OF THE EMBODIMENTS

The following discussion of the embodiments of the disclosure directed to sensorless and sensor-based feed optimization is merely exemplary in nature, and is in no way intended to limit the disclosed devices and techniques or their applications or uses.

The control of feed speed in machine tool operations is very important, as feed speeds which result in too high of a material removal rate can cause workpiece and/or tool damage, and feed speeds which result in too low of a material removal rate cause the cycle time of the machining operation to be longer than necessary. The present disclosure describes techniques for feed speed optimization which require no external sensors or only a simple accelerometer to be used with the machine tool, and are easily and cost-effectively implemented—not relying on expensive and difficult-to-use simulator software.

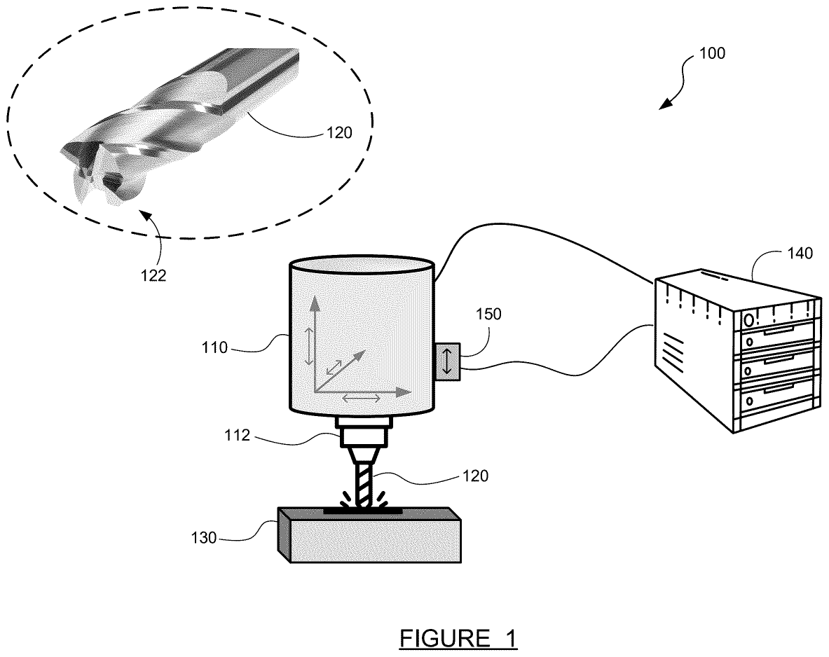

FIG. 1 is a schematic illustration of a system 100 including a computer-controlled machine tool performing a machining operation on a workpiece, of a type applicable to the techniques of the present disclosure. A machine tool 110 rotates a spindle 112 in which is secured a cutting tool, in this case an end mill 120. The machine tool 110 causes the end mill 120 to perform a machining operation on a workpiece 130. The machine tool 110 is in communication with a controller 140, which is a computing device that provides motion commands and spindle motor speed commands to the machine tool 110. In a typical example, the machine tool 110 would move the rotating end mill 120 from a start point along a path which causes material to be cut from the workpiece 130, disengage the end mill 120 from the workpiece 130 and move the end mill 120 back to a location near the start point, and then make another pass which cuts more material from the workpiece 130. The end mill 120 is shown in more detail in the inset, where the teeth or flutes are visible at a tip 122. In this example, the end mill 120 includes four teeth or flutes, also known as cutting edges. A sensor 150 is discussed later in connection with a sensor-based feed speed optimization technique.

As will be discussed in detail below, the techniques of the present disclosure are applicable to the system 100 of FIG. 1. Specifically, the presently disclosed sensorless feed speed optimization method may be programmed in the controller 140 using data that is readily available in the existing controller architecture. No sensors, microphones or other data acquisition devices are needed for data collection in some embodiments, and no integration of separate data acquisition or sensor sub-systems with the controller 140 is required.

The elements of FIG. 1 are depicted in rather simple fashion, where the machine tool 110 is movable in three principle axes of motion—including “vertically” (parallel to the axis of the end mill 120) and in two “horizontal” directions (orthogonal to the axis of the end mill 120). It is to be understood that the sensorless and sensor-based feed speed optimization methods of the present disclosure are applicable to any type of machine tool—including multi-axis machines with tool positioning and orientation capability, and robotically-controlled mills and drills with an articulated robot arm providing complete tool positioning and orientation flexibility.

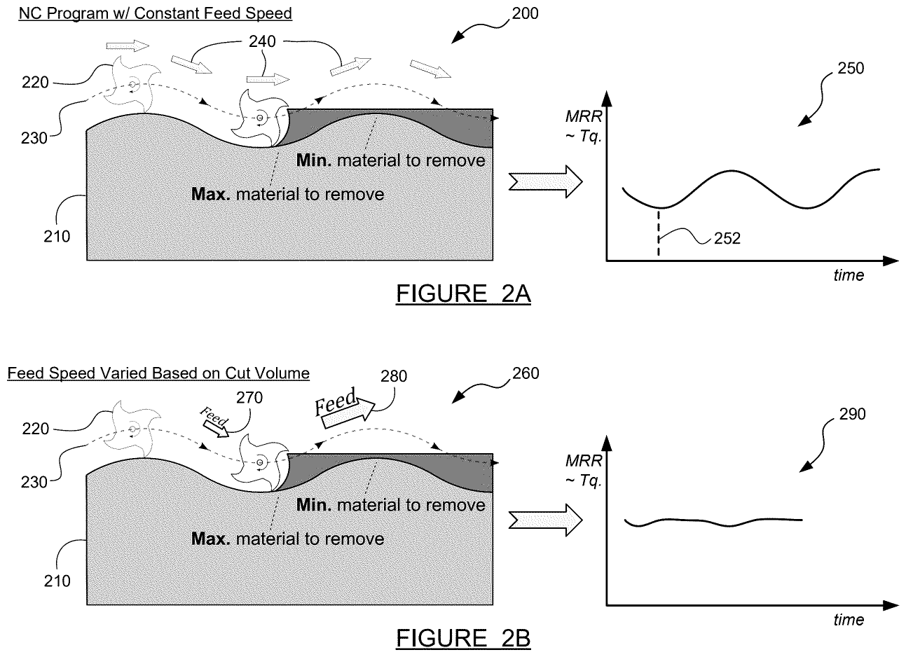

FIG. 2A is an illustration 200 of a machine tool cutting operation where the tool moves at a constant feed speed using a conventional programming technique. A workpiece 210 is being machined by a cutting tool 220 which follows a tool path 230 as shown. The machining operation of FIG. 2A is a type of operation which could be performed by the system of FIG. 1, where the workpiece 210 of FIG. 2A corresponds with the workpiece 130 of FIG. 1, and the cutting tool 220 corresponds with the end mill 120. The workpiece 210 is shown in a partially machined condition in FIG. 2A, where the material which is soon to be removed from the workpiece 210 is shown in a darker shade at the upper right portion of the workpiece 210. As illustrated, the tool path 230 is such that the amount of material removed from the workpiece 210 varies as the cutting tool 220 moves along the tool path 230.

In a traditional computer-numerically-controlled (CNC, or just NC) machining operation, the cutting tool feed speed is constant, and is determined in advance so as to ensure that the chip load on the cutting tool 220 (in particular the torque) remains at or below a prescribed target value. The constant feed speed is depicted by the series of arrows 240 in FIG. 2A. A graph 250 contains a plot of material removal rate (MRR) versus time for the machining operation depicted in the illustration 200. The MRR is the volume of material removed from the workpiece 210 per unit of time-such as in cubic millimeters per minute. The MRR is a function of the feed speed (or feed rate) of the cutting tool and the work volume (essentially the thickness of cut [vertically in FIG. 2A] and the axial depth of cut [into the page]). The torque on the cutting tool 220, which is also the spindle torque, varies approximately proportionately to the MRR; this is discussed further below. Thus, the vertical axis of the graph 250 is labeled with both MRR and Torque.

When the feed speed is held constant and the amount of material removed varies over the tool path as in the illustration 200, the MRR and spindle torque vary in relation to the amount of material removed. This is depicted in the graph 250. That is, when the amount of material being removed is small, as at the left-most instance of the cutting tool 220 in FIG. 2A, the MRR and spindle torque are small as shown at time 252 in the graph 250. The converse is also true; that is, when the amount of material being removed is large, the MRR and spindle torque are also large.

The constant feed speed used in the machining operation of FIG. 2A can keep the spindle torque below the target value, but does not maximize machine productivity because a higher cutting tool velocity could be used at many points along the tool path without exceeding the target spindle torque. The techniques of the present disclosure have been developed to meet both spindle torque limit (and cutting tool force) requirements and machine productivity requirements, and to do so using a method which requires no external sensors to be used with the machine tool and is also easy to implement.

FIG. 2B is an illustration 260 of a machine tool cutting operation where the tool moves at a feed speed which is varied based on an amount of material being removed, according to an embodiment of the present disclosure. In FIG. 2B, the workpiece 210, the cutting tool 220 and the tool path 230 are the same as in FIG. 2A. However, in FIG. 2B, the feed speed of the cutting tool 220 is varied as it moves along the tool path 230. Arrow 270 illustrates that the feed speed is reduced when relatively more material is being removed from the workpiece 210, and arrow 280 illustrates that the feed speed is increased when relatively less material is being removed from the workpiece 210.

A graph 290 contains a plot of material removal rate (MRR) versus time for the machining operation depicted in the illustration 260. Using the techniques of the present disclosure, discussed below, the changes in feed speed along the tool path are designed to allow the cutting tool to move faster where the depth of cut is small, while still meeting maximum spindle torque requirements by slowing the cutting tool down where the depth of cut is large. This results in a MRR in the graph 290 which is relatively uniform over the entire machining operation, in comparison to the highly variable MRR in the graph 250. This means that the spindle torque (and therefore the cutter's chip load) is also relatively uniform in the variable feed speed machining operation. As a result of the increased feed speed in areas of small depth of cut, the machining operation is completed in a shorter cycle time in the variable feed speed machining operation, which explains why the plot curve in the graph 290 is shorter (ends sooner) than the curve in the graph 250.

FIGS. 2A and 2B and their corresponding graphs are conceptual in nature, provided to illustrate the concepts of conventional constant feed speed and the feed speed optimization of the present disclosure. Details of the disclosed method, and results which depict the same characteristics shown in FIGS. 2A and 2B, are discussed below.

A basic premise of the presently-disclosed feed speed optimization technique is that the cutting torque is essentially proportional to the feed speed of the cutting tool. This can be understood by considering a cutting torque model represented as follows:

$$T = \frac{D}{2} ( c {K}_{t c} a sin θ + {K}_{t e} a ) \qquad ( 1 )$$

Where the first term inside the parentheses is the torque due to the cutting or shearing of material from the workpiece, and the second term inside the parentheses is the torque due to the rubbing or friction of the tool against the workpiece material. In Equation (1), T is the cutting torque on the tool, D is the tool diameter, c is the feed distance per tooth, K_{tc} is a force coefficient associated with the cutting/shearing (dependent on the workpiece material), a is the axial depth of cut, θ is the cutting edge engagement angle, and Kₜₑ is a force coefficient associated with the rubbing/friction.

Of the two terms in Equation (1), the cutting/shearing term is the much larger term. Thus, by ignoring the rubbing/friction term, Equation (1) can be simplified to:

$$T \approx \frac{D}{2} ( c {K}_{t c} a sin θ ) \qquad ( 2 )$$

In Equation (2), the only variable on the right-hand side is the cutting feed distance per tooth c. All other values are constants for a given machining operation (workpiece material, axial depth of cut, and cutting tool properties—size, shape and material). Furthermore, for a constant spindle rotational speed, the feed distance per tooth c is proportional to the feed speed. Thus, from Equation (2), it can be understood that the cutting torque is essentially proportional to the feed per tooth (i.e., T∝c) and thus the cutting torque is essentially proportional to the feed speed.

Based on the relationships discussed above, the sensorless feed speed optimization technique of the present disclosure uses recorded spindle torque command data from a reference machining cycle, computes a ratio of a target spindle torque to the recorded spindle torque command value at each positional step along the tool path, and uses the ratio to compute a new feed speed to be used at each positional step. The new feed speed profile along the tool path approximates an optimal feed speed profile for the reasons discussed above, and as described further below.

The first step in the disclosed technique is to record time-series spindle torque command data for a reference machining cycle. In a preferred embodiment, the machine tool is set up with a preprogrammed NC tool path, typically at a constant feed speed. As would be understood by those skilled in the art, the tool path may include many different cutting steps and “air cut” steps, where the cutting tool repeatedly positions, cuts material from the workpiece, repositions, performs a next cut, etc., until the machining operation is completed. Large air cut steps are typically programmed to be completed using maximum machine velocities and accelerations, so there is no need to modify such air cut steps for time optimization. The feed speed optimization is performed only on cutting steps and smaller air cut steps which exist within the programming of cutting steps.

To understand the reference machining cycle, consider the machining operation depicted in FIG. 2A, with a constant feed speed along the tool path 230. At each incremental position of the tool center point along the tool path 230, the spindle torque is recorded, along with the tool center point position. This will result in a time-series data set with the spindle torque and the tool center point position recorded at each time step. The feed speed along the tool path 230 for the reference machining cycle is also known. The time step increment (i.e., the amount of time and distance between each time-series data point) may be chosen to suit application requirements.

After the reference machining cycle is complete, the time-series data may be evaluated to determine the largest value of the spindle torque command over the entire reference machining cycle. This largest value may be defined as a spindle torque command target value SPTCMD_{TARG}. Alternately, the spindle torque command target value SPTCMD_{TARG} may be defined based on machine requirements, such as a value equal to 20% of the maximum machine spindle torque. Either of these techniques should result in a similar value for SPTCMD_{TARG}, as the constant feed speed of the reference machining cycle would have been chosen to cause the maximum spindle torque to be equal to the value based on machine requirements.

According to the presently-disclosed method, a new feed speed profile is then defined by comparing the spindle torque command value at each point in the reference machining cycle to the spindle torque command target value SPTCMD_{TARG}. The new feed speed profile is computed as follows:

$${Feed}_{optim , i} \approx {Feed}_{orig} \cdot ( \frac{{SPTCMD}_{TARG}}{{SPTCMD}_{i}} ) \qquad ( 3 )$$

Where, for each time-series data point in the reference machining cycle (i=1,n), a new feed speed Feed_{optim,i} is computed from the original feed speed Feed_{orig} (known and constant) and the ratio of SPTCMD_{TARG} Over SPTCMDᵢ. In Equation (3), SPTCMDᵢ is the recorded spindle torque command value for the particular time-series data point i. In the new feed speed profile, the new feed speed Feed_{optim,i} is used at the tool center point position (post) corresponding with the time step i. This results in a new feed speed profile where, at each tool center point position along the tool path, an optimum feed speed is defined.

It should be noted that the new feed speed profile will complete the machining cycle in a shorter amount of time than the reference machining cycle (as shown in the graphs of FIGS. 2A and 2B). Therefore, the new feed speed profile includes a set of positions (along the tool path) and corresponding feed speeds. The feed speed profile with positions and feed speeds can be converted to a time-step-based motion program where each time step has a corresponding position on the tool path trajectory and a corresponding feed speed.

Referring again to FIG. 2B, it can be understood how Equation (3) provides a new feed speed profile which is much more time-optimal than the original constant feed speed, while also ensuring that the commanded spindle torque does not exceed the target maximum value. At the instance of the cutting tool 220 immediately following the arrow 270, the maximum amount of material is being removed from the workpiece 210. Therefore, the value of the spindle torque command at that point (SPTCMDᵢ) should be very near the value of the spindle torque command target SPTCMD_{TARG}, which means that the feed speed at this point in the new speed profile will be very nearly equal to the original constant feed speed of the reference machining cycle.

Conversely, at the location of the arrow 280, the minimum amount of material is being removed from the workpiece 210. Therefore, the value of the spindle torque command at that point (SPTCMDᵢ) will be much lower than the value of the spindle torque command target SPTCMD_{TARG}, which means that the feed speed at this point in the new speed profile will be much greater the original constant feed speed of the reference machining cycle. The increased feed speed in areas of lesser material removal allows the machining operation to be completed more quickly using the new optimum feed speed profile.

In computing the new speed profile using Equation (3), some control parameters may be defined which limit the amount of increase or decrease of the feed speed. For example, feed speed at each point i in the new speed profile may be constrained to a range of 0.8 to 3.0 times the original feed speed. In other words, the new feed speed can be no slower than 0.8 times the original feed speed, and the new feed speed can be no faster than 3.0 times the original feed speed. These values are just examples, and any feed speed bounding limits may be chosen to suit a particular application.

It is emphasized that the recorded spindle torque command data for the reference machining cycle does not require a torque sensor in the machine tool or on the cutting tool. The spindle torque command data is known to the machine controller, as the controller monitors spindle rotational speed and provides torque commands (via motor current) to the spindle motor designed to maintain a target spindle speed. Thus, the technique described above is sensorless—using built-in capabilities of the machine tool (for measuring positions and velocities) and parameter data which is known to the machine controller.

In some embodiments, the spindle torque command time-series data for the reference machining cycle may be preprocessed to remove air-cutting torque. This is because the total spindle torque is equal to the cutting torque plus a friction torque in the machine tool itself. That is, Tₜₒₜₐₗ=Tₒᵤₜ+T_{friction}. The friction torque T_{friction} is the amount of torque required to turn the spindle at the cutting velocity without any tool-workpiece contact. Thus, the friction torque may be found during an air cut step.

In such embodiments where the air cut torque is removed, the air cut (friction) torque would also be removed from the target spindle torque command SPTCMD_{TARG}. Although the air cut (friction) torque is small in comparison to the actual cutting torque, removing the friction torque from the calculation of the optimum speed profile may provide slightly better results in some applications.

After the new feed speed profile is computed as discussed above, a new motion program for the machining operation may be prepared by using the original tool path geometric shape and inserting a new feed speed command for each position point along the tool path. This results in a motion program where the original tool path is followed and the feed speed along the tool path approximates an optimal feed speed profile. The new motion program may take the feed speed profile (comprising [position, feed speed] data pairs) and convert this to time-series data points for the new motion program, in a manner known in the art. This new motion program is then used by the machine controller in production machining operations.

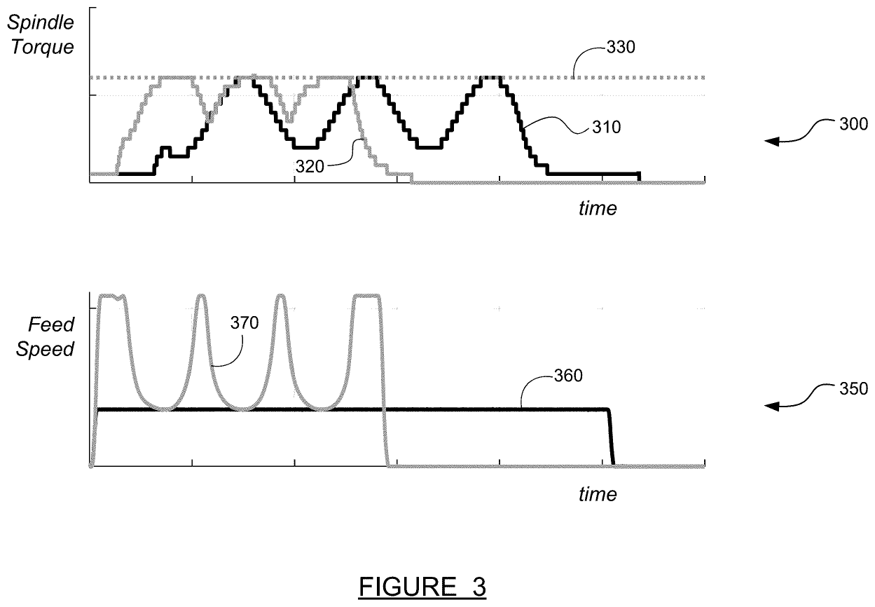

FIG. 3 includes a graph 300 of spindle torque versus time and a graph 350 of feed speed versus time, each graph including a data trace for a conventional constant feed speed and a data trace where the feed speed is varied based on the amount of material being removed according to an embodiment of the present disclosure. The graphs 300 and 350 represent results from an experimental implementation of a sinusoidal cutting path operation of the type depicted in FIG. 2, using the feed speed optimization technique described above.

In the graph 300, a data trace 310 plots spindle torque data for a conventional constant feed speed machining cycle, such as the one used for the reference machining cycle in the preceding discussion. The data trace 320 plots spindle torque data for a machining cycle where the motion program was created using the feed speed optimization technique discussed above. A line 330 represents the target spindle torque command SPTCMD_{TARG}.

It can be observed on the graph 300 that the spindle torque for the constant feed speed machining cycle (the data trace 310) oscillates between maximum and minimum values as the amount of material being removed from the workpiece varies. The maximum spindle torque values on the data trace 310 are equal to the target spindle torque, as expected. This is the behavior shown on the graph of FIG. 2A and discussed earlier. In contrast, the spindle torque for the optimized feed speed machining cycle (the data trace 320) has peaks and valleys, but the peaks spend more time at the target spindle torque value, and the valleys do not drop as far as on the constant feed speed data trace.

On the graph 350, the constant feed speed is shown in the data trace 360. In contrast, the feed speed for the optimized feed speed machining cycle (the data trace 370) increases dramatically in portions of the machining cycle where the amount of material removed is small, and drops back down to the feed speed of the conventional constant feed speed machining cycle in portions of the machining cycle where the amount of material removed is large. This is the behavior that is to be expected, given the feed speed optimization computational technique discussed above.

In the experimental implementation shown in the graphs 300 and 350, the maximum feed speed change for the optimized machining cycle was set to three times the constant feed speed of the reference machining cycle. This was done by applying feed speed bounding limits as discussed earlier. The factor of three feed speed increase can be seen in the data trace 370 compared to the data trace 360 on the graph 350. If the feed speed were allowed to be increased even further (more than 3×), this would reduce the size of the valleys in the data trace 320 on the graph 320. However, at some point, excessive feed speed increases would cause unacceptably jerky tool motion (sharper peaks in the data trace 370), and/or would exceed machine acceleration and jerk limits.

The results depicted in FIG. 3 clearly show that the feed speed optimization technique of the present disclosure produces a machining cycle with far less variation in spindle torque than in a conventional constant feed speed machining cycle, while still ensuring that the maximum spindle torque does not exceed the target spindle torque value. And most importantly, the machining cycle with feed speed optimization completes in far less time than the conventional constant feed speed machining cycle. In this experimental implementation, the machining cycle time was reduced by over 40% using the presently-disclosed feed speed optimization method. This cycle time reduction can be seen in both of the graphs in FIG. 3.

In another experimental implementation, the machining operation was machining a workpiece from a solid block of material, the workpiece including many bosses, ribs and cavities of varying height and thickness, resulting in complex tool-workpiece engagements, both internal and external to the workpiece. In this experimental implementation, the maximum feed speed increase for the optimized machining cycle was set to two times the original feed speed. In this example, the machining cycle time was reduced by almost 20%, compared to the constant feed speed machining cycle, using the presently-disclosed sensorless feed speed optimization method.

The feed speed optimization technique described above may be thought of as a type of feedforward control—where changes to feed speed are made in anticipation of imminent changes in the amount of material being removed from the workpiece. In another embodiment, feedforward control using feed speed optimization may be combined with real-time feedback control to provide more robust and effective feed speed management.

In a known feedback control system for a machine tool, spindle torque data is monitored in real time by the machine controller, possibly along with other parameters such as spindle temperature. If the spindle torque value reaches a predefined threshold (similar to the target spindle torque command discussed above), the machine controller lowers the feed speed as needed to bring the spindle torque value back down to or below the threshold spindle torque value. Because of the nature of feedback control, some overshoot of the threshold spindle torque value may be unavoidable, especially in high speed machining operations. By combining feedforward and feedback control of a machining operation, the best characteristics of both control strategies may be realized.

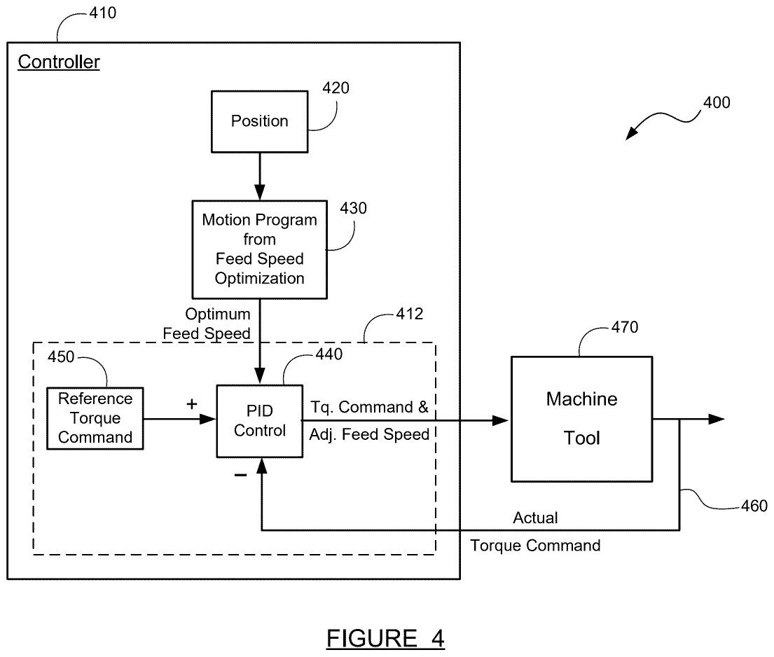

FIG. 4 is a block diagram of a system 400 for sensorless feed optimization with supplemental feedback control, including providing a reference feed speed from an optimized feed speed profile and adjusting the reference feed speed using feedback control, according to an embodiment of the present disclosure. In the system 400, a machine controller 410 controls a machine tool 470, in the manner shown in FIG. 1 and discussed earlier.

In the presently-disclosed feed speed optimization technique, the controller 410 is provided with a motion program which contains an optimum feed speed for every position point along a tool path, in accordance with the presently-disclosed sensorless feed speed optimization described in detail above. Then at every time step during the actual execution of the machining cycle on production parts, the tool center point position from a block 420 is provided to a motion program block 430 which determines the optimum feed speed based on the tool center point position along the tool path. In a basic implementation of the feed speed optimization method, the optimum feed speed from the block 430 is provided to the machine tool 470, which uses the feed speed as commanded.

In a more advanced implementation, feedback control may be employed by adding the elements inside a dashed box 412. In this embodiment, the optimum feed speed from the block 430 is provided as a reference feed speed to a feedback control block 440. The feedback control block 440 computes an adjusted feed speed based on a difference between a reference spindle torque command value (the torque value that the feedback control is targeting; provided from a block 450) for the current time step and the actual torque command from the previous time step (provided as feedback from the machine tool 470 on a line 460). The feedback control block 440 may employ PID control, or some other feedback control algorithm, as known in the art.

If the actual spindle torque command is greater than the reference torque command, the feedback control block 440 computes an adjusted feed speed which is lower than the optimum feed speed from the block 430. Conversely, if the actual spindle torque command is less than the reference torque command, the feedback control block 440 computes an adjusted feed speed which is higher than the optimum feed speed from the block 430. In a PID control system, the feed speed adjustment calculations are performed using proportional-integral-derivative logic, not just based on a simple difference. The output from the feedback control block 440 is the adjusted feed speed, which is provided as a command to the machine tool 470. The spindle torque command, designed to keep the spindle turning at the target rotational velocity, is also provided to the machine tool 470.

The combination of feedback control of cutting tool feed speed with the preparation in advance of an optimal feed speed profile, as depicted in FIG. 4, can provide the advantages of both feedforward and feedback control strategies. The feedforward reference speed provides a theoretically optimum feed speed for all points along a tool path, while the real-time feedback control makes smaller scale adjustments as needed to prevent cutting torque overshoots while also allowing feed speed increases where possible. The adjustments made by the feedback control module 440, which are typically fairly minor, may be necessary for reasons such as a misalignment of an actual workpiece position from the nominal workpiece position defined in the machine tool motion program. An experimental implementation of this combined control strategy demonstrated very effective reduction of spindle torque command overshoots.

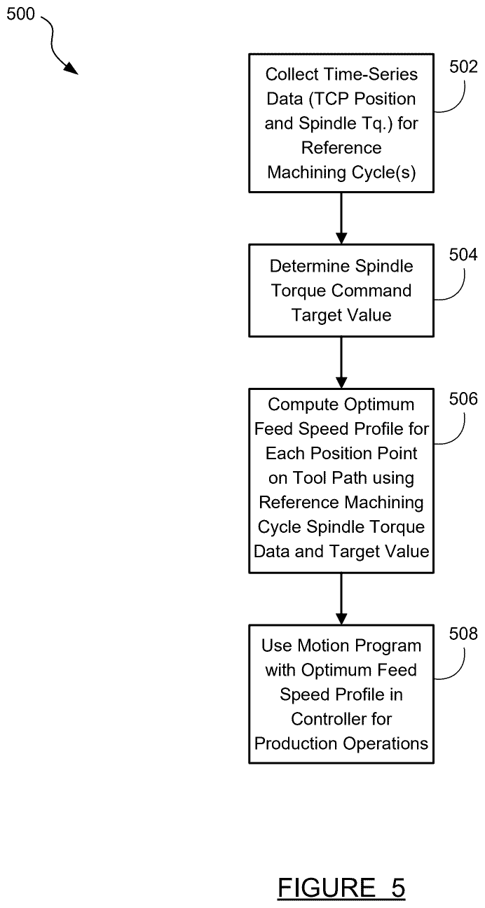

FIG. 5 is a flowchart diagram 500 of a method for sensorless feed speed optimization, including calculation of an optimum feed speed profile based on spindle torque data from a reference machining cycle, according to an embodiment of the present disclosure.

At box 502, time-series data for a reference machining cycle is collected from a machine tool controller. The time-series data includes, for each time step, a tool center point position along a prescribed tool path and a corresponding spindle torque command value. In a preferred embodiment, the reference machining cycle is performed using a motion program (e.g., from NC or CNC) which applies a constant feed speed of the cutting tool along the tool path. If variable feed speeds are used in the reference machining cycle, then the feed speed for each time-series data point is recorded along with the tool center point position and the spindle torque command.

At box 504, a spindle torque command target value (SPTCMD_{TARG}) is determined. The spindle torque command target value may be defined as largest value of the spindle torque command over the entire reference machining cycle. Alternately, the spindle torque command target value may be defined based on machine requirements, such as a value equal to 20% of the maximum machine spindle torque. Either approach should yield a similar value for SPTCMD_{TARG}.

At box 506, an optimum feed speed profile for the tool path is computed. As discussed earlier, for each time step i in the reference machining cycle data set, a new optimum feed speed is computed using Equation (3), where the new feed speed is equal to the original feed speed for the time step multiplied by the ratio of SPTCMD_{TARG} over SPTCMDᵢ, where SPTCMDᵢ is the recorded spindle torque command value for the particular time-series data point i. In the new optimum feed speed profile, the new feed speed Feed_{optim,i} is used at the tool center point position (post) corresponding with the time step i. This results in a new feed speed profile where, at each tool center point position along the tool path, an optimum feed speed is defined.

As discussed earlier, in computing the optimum feed speed profile at the box 506, bounding limits may be applied to the feed speed increase or decrease calculated from Equation (3). For example, a maximum feed speed increase or decrease by a factor of two, or a factor of three, may be prescribed. The speed increase factor may be different than the speed decrease factor, and these factors may be chosen to suit application requirements.

As also discussed earlier, in computing the optimum feed speed profile at the box 506, the spindle torque values (for both SPTCMD_{TARG} and SPTCMDᵢ) may be preprocessed to subtract out the air cut (friction) torque, so that the optimum feed speed calculations are performed directly on the torque associated with material cutting, without including the parasitic friction torque.

At box 508, a motion program is created with the optimum feed speed profile and used in the machine controller for production machining operations. The motion program used at the box 508 contains an optimum feed speed for every position point along the tool path, as computed at the box 506. This results in a motion program where the original tool path is followed and the feed speed along the tool path approximates an optimal feed speed profile.

In an alternate embodiment, the machine controller performing the production machining operations at the box 508 uses the new motion program with the optimum feed speed profile, and also employs a feedback control block to adjust the commanded feed speed based on the actual spindle torque, as depicted in FIG. 4. The use of feedback control, in addition to the optimum feed speed feedforward command, enables automatic real-time fine-tuning of the feed speed to account for unexpected overshoots or undershoots of the target spindle torque.

The sensorless feed speed optimization techniques discussed above have been shown to be very effective in maintaining cutting tool loads at or below a target value while reducing cycle times compared to constant-speed machining. The sensorless techniques are applicable to machining operations where the amount of material being removed from a workpiece is substantial enough to cause significant variations in spindle torque along the machining trajectory of the tool path. However, in other applications, such as machining small components for electronic devices, a combination of small cutting tool diameter and low material removal rate result in insignificant variations in spindle torque over the course of the machining operation, thus rendering the sensorless spindle torque command-based technique ineffective. In these applications, an acceleration sensor may be added to the machine tool and the acceleration signals analyzed for the purpose of feed speed optimization. This technique is discussed below.

The basic premise of the sensor-based feed speed optimization technique is that both lateral and axial force on the cutting tool are generally proportional to the tool feed speed. Even though the cutting tool may be moving perpendicular to the tool axis, cutting by the tool results in an axial force (in addition to a lateral force) in part because the cutting tool has a helical cutting edge profile (see the cutting tool 120 in the inset of FIG. 1). Additionally, if the cutting tool has an axial component of motion (such as when ramping down into the workpiece material), this will also cause an axial force which is dependent on feed speed.

The above discussion can be represented mathematically as follows:

$${F}_{axial} \approx c {K}_{a c} a sin θ \qquad ( 4 )$$

Where Fₐₓᵢₐₗ is the axial cutting force on the tool, c is the feed distance per tooth, K_{ac} is a force coefficient associated with the cutting, a is the axial depth of cut, and θ is the cutting edge engagement angle. As explained earlier with respect to Equation (1), three of the parameters (K_{ac}, a, θ) in Equation (4) are constants for a given machining operation (tool shape and workpiece material), which leads to the conclusion that Fₐₓᵢₐₗ∝c. That is, the axial force on the tool is essentially proportional to the feed distance per tooth, i.e., the cutting feed speed.

Rather than directly measuring axial force on the cutting tool, it has been demonstrated that time-series axial acceleration data can be processed and analyzed to detect changes in axial force on the cutting tool. Thus, a Z-axis acceleration signal can be used as a proxy for axial force on the tool, which in turn is related to cutting force in the lateral (X and Y) directions. The variations in cutting force, as determined from the axial acceleration signal, can be used to calculate an optimal feed speed profile.

Returning to FIG. 1, a sensor 150 is fitted to the machine tool 110. In a preferred embodiment, the sensor 150 is an acceleration sensor and, more specifically, an acceleration sensor configured to measure time-series-acceleration data in the axial direction (parallel to the spindle axis; a.k.a., the Z direction, as indicated by the arrow). The sensor 150 collects time-series data during the machining operation and provides the acceleration data to the controller 140, where the collected data (e.g., Z-axis acceleration data) is correlated to the location of the tool center point along the tool path during the machining operation, and the sensor data is then analyzed to compute an optimal feed speed profile in a manner similar to the sensorless technique described earlier.

For the purposes of the following discussion, an acceleration parameter X is defined which is used in the feed speed optimization computations. In one embodiment, the time-series data from the axial acceleration sensor is double integrated and high-pass filtered to produce time-series data X_{orig}. The double integration transforms the axial acceleration data into the equivalent of axial displacement, which varies with axial force. The high-pass filtering removes drift from the time-series data. The double integration and high-pass filtering is just one example of a data processing technique to produce X_{orig} from the raw time-series axial acceleration data. Other techniques may be used as determined suitable.

In some preferred embodiments, the acceleration sensor 150 provides data measurements at a faster rate than the time step increment used by the controller 140 to control the machine tool 110. Thus, for every time step of the controller, multiple axial acceleration data points are available, which helps prevent spikes and dips in the acceleration data from artificially affecting the acceleration parameter X.

A moving average or other low-pass filter is then applied to the X_{orig} time-series data to produce the time-series data for the acceleration parameter X as follows:

$$X ( t ) = movavg ( \vert {X}_{orig} ( t ) \vert ) \qquad ( 5 )$$

Where X_{orig} (t) is the time-series acceleration data after double integration and high-pass filtering (or other data processing) as described above, and X(t) is the time-series acceleration parameter data which will be used in the feed speed optimization computation.

As with the sensorless feed speed optimization technique discussed earlier, the sensor-based method begins with recording time-series data for a reference machining cycle—in this case, axial acceleration data for each point along the tool path. In a preferred embodiment, the machine tool is set up with a preprogrammed NC tool path, typically at a constant feed speed. During the reference machining cycle, at each incremental position of the tool center point along the tool path 230 (FIG. 2), the axial acceleration is recorded, along with the tool center point position. This results in a time-series data set with the axial acceleration and the tool center point position recorded at each time step. The feed speed along the tool path 230 for the reference machining cycle is also known. The time step increment (i.e., the amount of time and distance between each time-series data point) may be chosen to suit application requirements.

After the reference machining cycle is complete, the time-series data may be evaluated to determine the largest value of the acceleration parameter X (computed from the axial acceleration data) over the entire reference machining cycle. This largest value may be defined as a target acceleration amplitude value X_{TARG}.

According to the presently-disclosed sensor-based method, a new feed speed profile is then defined by comparing the axial acceleration amplitude value at each point in the reference machining cycle to the target acceleration amplitude value X_{TARG}. The new feed speed profile is computed as follows:

$${Feed}_{optim , i} \approx {Feed}_{orig} \cdot ( \frac{{X}_{TARG}}{{X}_{i}} ) \qquad ( 6 )$$

Where, for each time-series data point in the reference machining cycle (i=1, n), a new feed speed Feed_{optim,i} is computed from the original feed speed Feed_{orig} (known and constant) and the ratio of X_{TARG} over Xᵢ. In Equation (6), Xᵢ is the computed value of X (from Equation (5), based on the original axial acceleration data) for the particular time-series data point i. In the new feed speed profile, the new feed speed Feed_{optim,i} is used at the tool center point position (post) corresponding with the time step i. This results in a new feed speed profile where, at each tool center point position along the tool path, an optimum feed speed is defined.

For points along the tool path where Xᵢ<X_{TARG}, the optimal feed speed will be increased over the original feed speed, in order to improve cycle time. For points along the tool path where Xᵢ>X_{TARG}, the optimal feed speed will be decreased from the original feed speed, in order to prevent excessive load on the cutting tool. Limits may be placed on the amount of feed speed increase or decrease which allowed in the optimal feed speed profile, as discussed previously in connection with Equation (3).

The sensor-based feed speed optimization works in the same way and for the same reasons as discussed earlier with respect to FIG. 2. That is, in parts of the tool path where the material removal rate is low, feed speed may be increased relative to the nominal value, and vice versa. When applied to a sinusoidal tool path of the same type depicted in FIG. 2, the sensor-based solution resulted in an optimized feed speed profile similar to the one depicted in FIG. 3 and discussed earlier—with many parts of the machining cycle operating at feed speeds significantly greater than the nominal constant feed speed. Again it is emphasized that this feed speed optimization is achieved using the sensor-based technique even though spindle torque command data is not used because the machine controller cannot detect any variations in spindle torque.

It is again noted that the new feed speed profile will complete the machining cycle in a shorter amount of time than the reference machining cycle—as shown in the graphs of FIGS. 2A and 2B, and discussed earlier. In the example discussed above, the sensor-based technique produced a feed speed profile which completed the machining operation in about 32% less time than the constant feed speed machining cycle. The new feed speed profile includes a set of positions (along the tool path) and corresponding feed speeds, which may be used by the controller in any suitable fashion to control the machine tool motion according to the feed speed profile.

The advantages of combining feedback control of feed speed with feed-forward control were discussed earlier with respect to the sensorless feed speed optimization technique, and a block diagram illustration of such a system was shown in FIG. 4. This same approach may also be employed with sensor-based feed speed optimization. It should be noted that in this case, instead of using the actual torque command as feedback on the line 460 (which is data known to the machine controller), it is necessary to use the real-time axial acceleration signal from the sensor 150 for feedback.

In some embodiments of the sensor-based feed speed optimization technique, an additional feature may be added to address the issue of direction-dependent vibration cross-coupling in the machine tool. Consider a machine coordinate frame where the Z-axis is parallel to the spindle axis (e.g., vertical) as discussed above, and the X- and Y-axes are oriented in “fore-aft” and “lateral” cutting directions (e.g., in a horizontal plane). Machine tool design considerations dictate that the structure and mechanization for tool travel in one direction (e.g., X) are different than those for tool travel in the orthogonal direction (e.g., Y). This means that the stiffness/flexibility characteristics are different in the X- and Y-directions, and gives rise to direction-dependent vibration in the machine tool. Such vibration can also have cross-coupling effects which also depend on the machine tool design. In other words, X-direction vibration can be felt somewhat in the Y- and Z-directions, and vice versa. Furthermore, X-direction vibration results in a different vibration signature in the Z-direction than does Y-direction vibration.

Stated differently, the Z-direction acceleration which results from cutting in the Y-direction may be much different than the Z-direction acceleration which results from cutting in the X-direction. Because the sensor-based feed speed optimization technique is based on the magnitude of Z-direction acceleration, it may be advantageous to consider the cutting direction when processing the acceleration data. This can be done by dividing the complete tool path trajectory into feed angle groups, and using a unique value of X_{TARG} for each feed angle group.

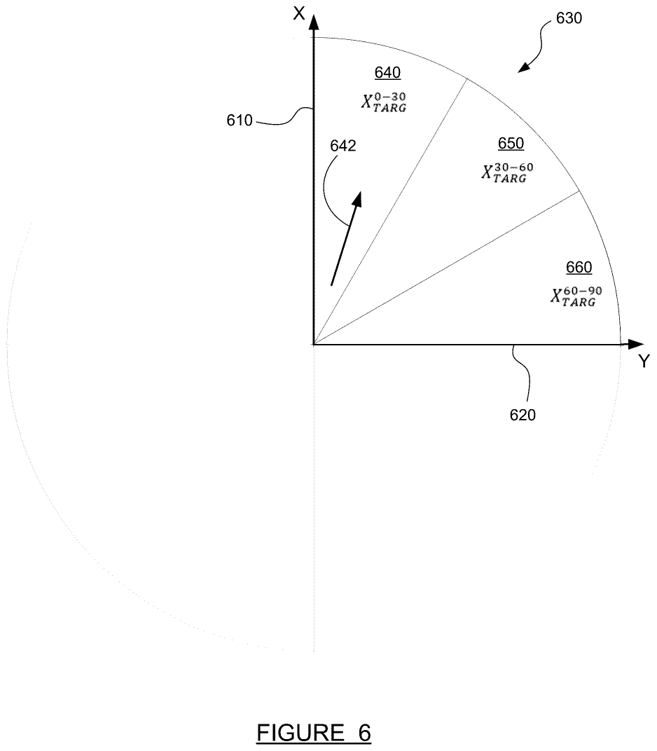

FIG. 6 is a plan view illustration of a machine tool feed angle workspace in a sensor-based feed speed optimization implementation, where a plurality of sectors are defined, and a target value is selected at each time step based on which sector the tool feed angle vector falls within, according to an embodiment of the present disclosure. FIG. 6 shows an X axis direction 610 and a Y axis direction 620 of a machine tool coordinate frame. In the machine tool coordinate frame, the Z axis points downward, parallel to the axis of the cutting tool. These definitions are consistent with the coordinate directions used throughout the present disclosure. The X and Y directions in FIG. 6 related to tool velocity, not position, as discussed below.

A quadrant 630 is defined for the portion of the machine tool feed angle workspace where the feed angle of the cutting tool has a positive X component and a positive Y component. The feed angle is the velocity or direction of motion of the cutting tool at any particular point along a tool path. The quadrant 630 is divided into three sectors: a sector 640 describes cutting tool feed angles between 0° and 30° from the X axis; a sector 650 describes feed angles between 30° and 60° from the X axis; and a sector 660 describes feed angles between 60° and 90° from the X axis. During the reference machining cycle, the feed angle at each time step is recorded, along with the corresponding axial acceleration data. A different value of X_{TARG} is computed for each of the sectors 640, 650 and 660. That is, the target value

$${X}_{TARG}^{0 - 30}$$

is determined from the portions of the reference machining cycle where the feed angle is within the sector 640, and similarly for the sectors 650 and 660. Determining a different value of X_{TARG} for each feed angle group recognizes the fact that a particular feed speed in the X direction may cause a significantly different axial acceleration in the machine tool than the same feed speed in the Y direction

Then, to compute the optimal feed speed profile, Equation (6) is used for each point i as before, but the value of X_{TARG} is selected for the appropriate feed angle group for the point i. For example, for a point on the machining cycle trajectory where the cutting tool has a feed angle vector 642, the time-series acceleration data parameter Xᵢ is used along with the target value

$$( {X}_{TARG}^{0 - 30} )$$

for the sector 640 which corresponds with the feed angle vector 642. This is how the concept of feed angle groups is applied to counteract the effects of direction-dependent vibration cross-coupling in the machine tool.

The approach for defining feed angle groups, described above for the quadrant 630, may of course be applied to feed angles falling in the other quadrants as well (negative X and/or Y velocity directions). The other quadrants may be symmetric with the quadrant 630, or uniquely defined. Furthermore, 30° sectors is just one non-limiting example; more or fewer than three sectors may be contained in each quadrant, and the sectors need not all be the same size. The sectors sizes for the feed angle groups may be defined to meet application requirements and based on machine tool characteristics.

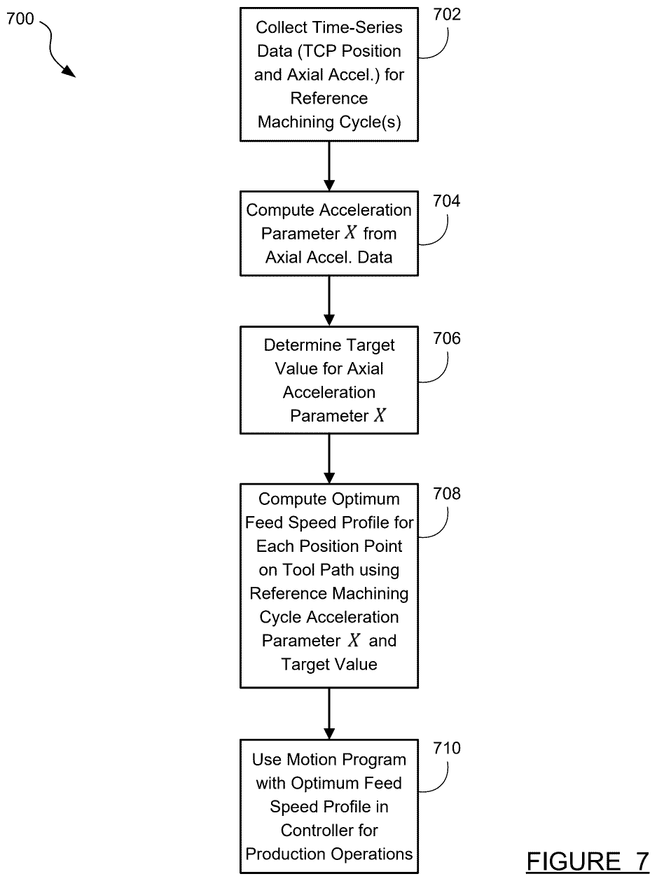

FIG. 7 is a flowchart diagram 700 of a method for sensor-based feed speed optimization, including calculation of an optimum feed speed profile based on axial acceleration data from a reference machining cycle, according to an embodiment of the present disclosure.

At box 702, time-series data for a reference machining cycle is collected from a machine tool controller, including axial acceleration data from a sensor mounted to the machine tool. The time-series data includes, for each time step, a tool center point position along a prescribed tool path and a corresponding axial acceleration value. In a preferred embodiment, the reference machining cycle is performed using a motion program (e.g., from NC or CNC) which applies a constant feed speed of the cutting tool along the tool path. If variable feed speeds are used in the reference machining cycle, then the feed speed for each time-series data point is recorded along with the tool center point position and the axial acceleration value.

The axial acceleration data from the sensor may be provided at a higher frequency than the frequency of the control cycle of the controller. In other words, for every time step of the controller controlling the machine tool on the tool path, multiple acceleration data points may be received from the sensor and recorded, so that averaging or other data processing techniques have more data to consider and therefore are less affected by individual spikes in the acceleration data.

At box 704, an acceleration-related parameter X is computed from the raw axial acceleration time-series data. As discussed earlier, the acceleration parameter X has a value at each time-series data point which may be a peak value of the axial acceleration, or may be a double integral of the acceleration signal. Other data processing techniques may be applied to the original time-series acceleration data in order to provide the acceleration parameter X, which is intended to be representative of the amplitude of the axial acceleration (and therefore the force on the cutting tool) at each time step in the machining cycle.

At box 706, a target value for the acceleration parameter X is determined. The target value is designated X_{TARG}, and may be defined as the largest value of the acceleration parameter X over the entire reference machining cycle. In some embodiments, each path point in the machining cycle is assigned to a feed angle group based on the direction of the tool's velocity vector, and a target value X_{TARG} is computed for each of the feed angle groups.

At box 708, an optimum feed speed profile for the tool path is computed. As discussed earlier, for each time step i in the reference machining cycle data set, a new optimum feed speed is computed using Equation (6), where the new feed speed is equal to the original feed speed for the time step multiplied by the ratio of X_{TARG} over Xᵢ, where Xᵢ is the value of the acceleration parameter X for the particular time-series data point i. In the new optimum feed speed profile, the new feed speed Feed_{optim,i} is used at the tool center point position (post) corresponding with the time step i. This results in a new feed speed profile where, at each tool center point position along the tool path, an optimum feed speed is defined.

As discussed earlier, in computing the optimum feed speed profile at the box 708, bounding limits may be applied to the feed speed increase or decrease calculated from Equation (6). For example, a maximum feed speed increase or decrease by a factor of two, or a factor of three, may be prescribed. The speed increase factor may be different than the speed decrease factor, and these factors may be chosen to suit application requirements.

As also discussed earlier, in computing the optimum feed speed profile at the box 708, each time-series data point may first be assigned to a feed angle group, and each feed angle group has its own unique value of X_{TARG} to be used in Equation (6). The feed angle group processing feature counteracts the effects of direction-dependent vibration cross-coupling in the machine tool, and may provide improved results in some applications-such as applications where the machining cycle includes a wide range of feed angles and the machine tool has dramatically different stiffness characteristics in the fore-aft direction versus the lateral direction.

At box 710, a motion program is created with the optimum feed speed profile and used in the machine controller for production machining operations. The motion program used at the box 710 contains an optimum feed speed for every position point along the tool path, as computed at the box 708. This results in a motion program where the original tool path is followed and the feed speed along the tool path approximates an optimal feed speed profile. In the sensor-based solution, the optimum feed speed profile is produced without processing spindle torque command data, which is essential for applications such as electronics machining where variations in spindle torque are too small to be detected.

In an alternate embodiment, the machine controller performing the production machining operations at the box 708 uses the new motion program with the optimum feed speed profile, and also employs a feedback control block to adjust the commanded feed speed based on the actual axial acceleration value measured in real time, as discussed earlier. The use of feedback control, in addition to the optimum feed speed feedforward command, enables automatic real-time fine-tuning of the feed speed to account for unexpected overshoots or undershoots of the cutting force.

The sensorless and sensor-based feed speed optimization techniques described above provide powerful capabilities for creating a machining feed speed profile which minimizes machining cycle time while avoiding excessive spindle torque or material removal rate. Another factor which is important in machining operations is surface roughness of the finished workpiece. A technique for predicting nominal surface roughness in finishing operations is discussed below.

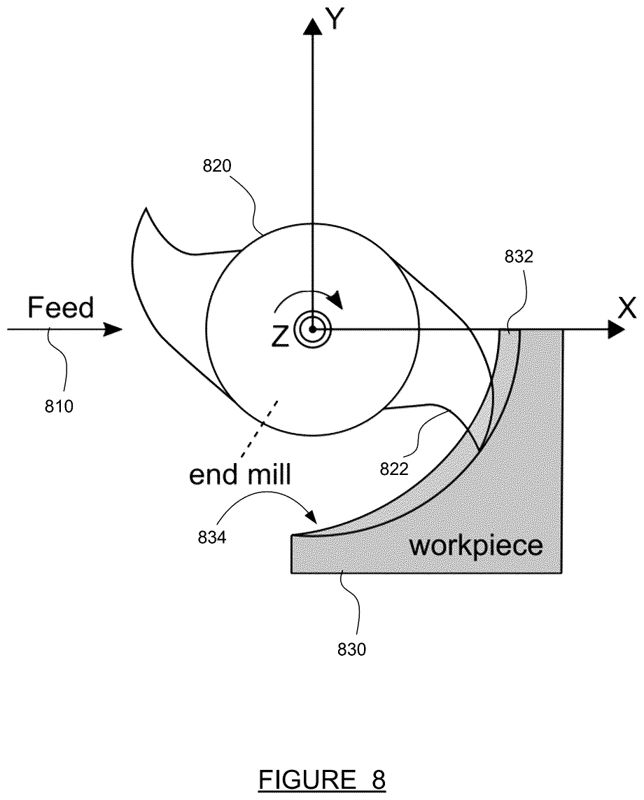

FIG. 8 is an illustration of a machining operation, depicting how tool motion creates a scalloped shape on a surface of a workpiece, provided to shown concepts used in the surface roughness prediction techniques of the present disclosure. FIG. 8 illustrates a machining operation of the same type depicted in FIGS. 1 and 2. A machine tool (not shown) moves in a direction indicated by a feed arrow 810. The machine tool has in its spindle a cutting tool 820 (e.g., an end mill) which is rotating at a spindle speed S and moving at a linear feed speed F. The spindle rotates about a Z axis, and the machine tool moves in a direction normal to the spindle axis—in this case in an X direction, as indicated by the coordinate frame depicted in FIG. 8.

A workpiece 830 is fixed in position and being machined by the cutting tool 820. On each rotation of the cutting tool 820, a flute 822 cuts and removes a cut portion 832 of material from the workpiece 830. The size and shape of the cut portion 832 is dependent on the spindle speed S and the feed speed F, along with the diameter of the cutting tool 820 and the number of flutes on the cutting tool 820 (discussed further below). If the feed speed F is vanishingly small, the cutting tool 820 will leave a smooth surface on the workpiece 830. However, because the flute 822 moves in the X direction from one rotation to the next, in reality the cutting tool 820 will leave a “scalloped” shape on the machined surface of the workpiece 830—particularly at the bottom portion of the machined surface, indicated at 834.

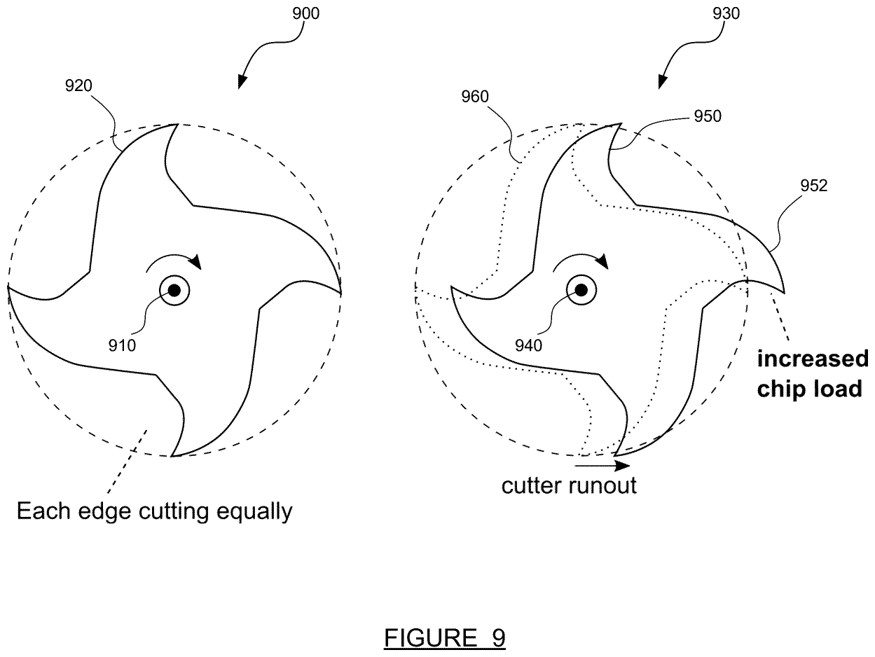

FIG. 9 is an illustration of an ideal cutting tool with a perfect shape and a real-world cutting tool with runout, depicting how tool runout affects the scalloped shape of the workpiece after machining and how this effect can be simulated in embodiments of the present disclosure. A cutting tool 900 at the left has an axis of rotation 910. The cutting tool 900 has a perfectly axisymmetric shape, such that each of the flutes 920 has an equal tip diameter, meaning that-under constant spindle speed and feed speed conditions—each of the flutes 920 cuts the same amount of material from the workpiece on each rotation of the tool. The cutting tool 900 embodies an idealized tool; however, in practice, there is always some asymmetry to cutting tools.

A cutting tool 930 at the right has an axis of rotation 940. The cutting tool 940 embodies a real-world example of a cutting tool with runout. Runout is the term used to describe the condition where the pattern of the cutting flutes is offset from the axis of rotation of the cutting tool. The cutting tool 930 has flutes 950 (shown in solid outline) which are offset laterally to the right from an idealized pattern of flutes 960 (shown in dotted outline). This condition is independent of feed speed or direction; it is a characteristic of the cutting tool 930 itself. The implication of tool runout is that one particular flute (952) which is aligned with the direction of runout will cut most of the material from the workpiece on each rotation of the cutting tool 930. Techniques are discussed below for simulating the workpiece surface roughness given a set of machining operation parameters, where these techniques can optionally be configured to account for the effects of tool runout.

Workpiece surface roughness from a machining operation can be simulated based on parameters including cutting tool diameter, feed speed and spindle speed. This simulation is described in connection with the following figure.

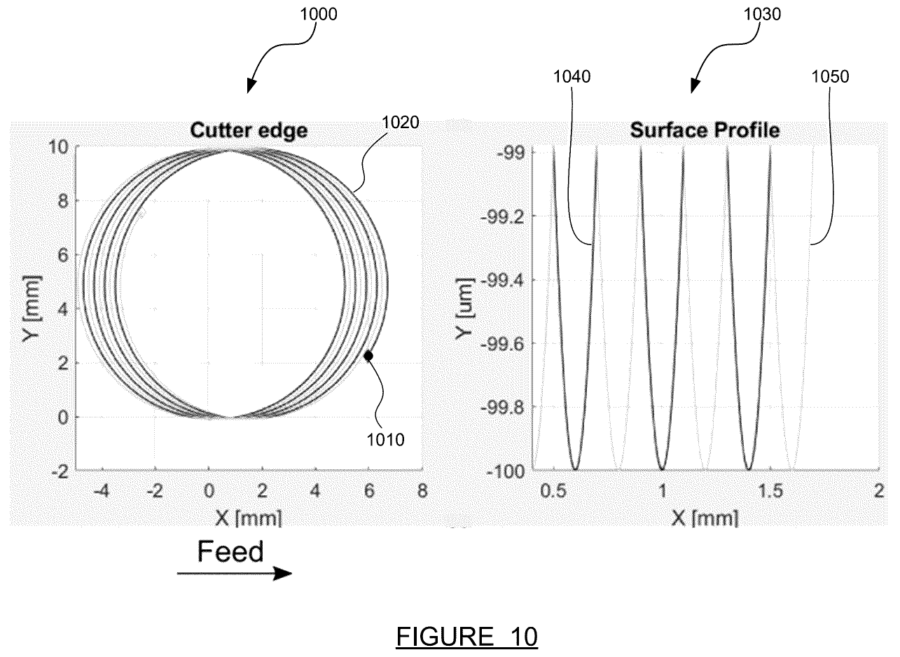

FIG. 10 is an illustration of a path of a tip of a flute of a cutting tool in a plane of motion and a corresponding surface profile, depicting how workpiece surface roughness is simulated in embodiments of the present disclosure. A cutting tool such as the one shown in FIG. 8, with two flutes, is modeled in a graph 1000. The cutting tool moves in an X-Y plane (the plane of motion of the cutting tool) perpendicular to the Z axis which is the spindle rotation axis, in the same convention used earlier. One of the flutes has a tip whose path is represented by a point 1010. As the cutting tool rotates and moves in the feed direction indicated, the point 1010 traces a path 1020. The opposite flute of the cutting tool traces a path similar to the path 1020 but a half rotation out of phase.

The graph 1000 was created using the following technique. The tip of each cutting tool flute is given initial coordinates in the X-Y plane. For example, the tip of the cutting tool flute represented by the point 1010 may be given initial coordinates which correspond with a position on the “equator” of the cutting tool, and trailing the feed direction. The opposite flute would then be given initial coordinates for a position on the equator of the cutting tool and leading the feed direction. Based on the feed speed and the spindle speed, it can be determined how far each flute tip travels in the feed direction per rotation of the cutting tool. For example, at a spindle speed of 1000 rpm and a feed speed of 100 mm/minute, the cutting tool travels 0.1 mm/rev. Then the spatial motion of the point 1010 can be calculated at discrete points for each simulation step. That is, if the simulation uses a step of one degree of spindle rotation, then from one step to the next, the point 1010 rotates one degree about the spindle axis (providing new X and Y coordinates) and also translates in the X direction by an amount determined by ΔX=(0.1 mm/rev)*( 1/360 rev). Using the new X and Y coordinates due to tool rotation and the translation ΔX, the position of the point 1010 can be calculated at each simulation step. When the X and Y coordinates of the point 1010 are plotted for all simulation steps, the result is the path 1020.

A graph 1030 shows the surface profile of the workpiece after being cut by the cutting tool flute moving along the path 1020, and the opposite flute. The graph 1030 is highly magnified—having vertical axis (Y) units of micrometers as compared to the tool path trace graph 1000 which has vertical axis units of millimeters. In the graph 1030, the surface shape created by the path 1020 is shown in a profile 1040 (dark line font), while the surface shape created by the opposite flute is shown in a profile 1050 (lighter line font). From the profiles 1040 and 1050, workpiece surface roughness may be computed in any suitable fashion. Embodiments of surface roughness metrics from the simulation include an absolute average of the surface profile, a root mean square (RMS) of the surface profile, and a peak to valley height. Other metrics may be used as appropriate.

The surface roughness simulation technique described above can be modified to simulate cutting tools with more than two flutes (e.g., four), and/or to accommodate asymmetrical cutting tool geometry-such as unequal pitch (flutes not spaced equally), and runout (discussed above, where one flute does most of the cutting). In all cases, the simulation provides a predicted surface roughness metric for a given set of feed speed and spindle speed conditions.

Parts which are machined in the type of machining operation described in the present disclosure typically have a surface roughness tolerance which must be met. Thus, the surface roughness prediction calculated as shown in FIG. 10 may be compared to the part tolerance to determine whether the machining operation parameters will result in acceptable workpiece surface finish/roughness. Recall that the objective of the sensorless and sensor-based feed speed optimization techniques discussed earlier is to increase the feed speed wherever possible in the machining cycle, where the material removal rate is small. The speed-up obtained from feed speed optimization might result in unacceptably high surface roughness; therefore, it is desirable to evaluate surface roughness after performing the feed speed optimization calculations, before implementing the optimized feed speed profile.

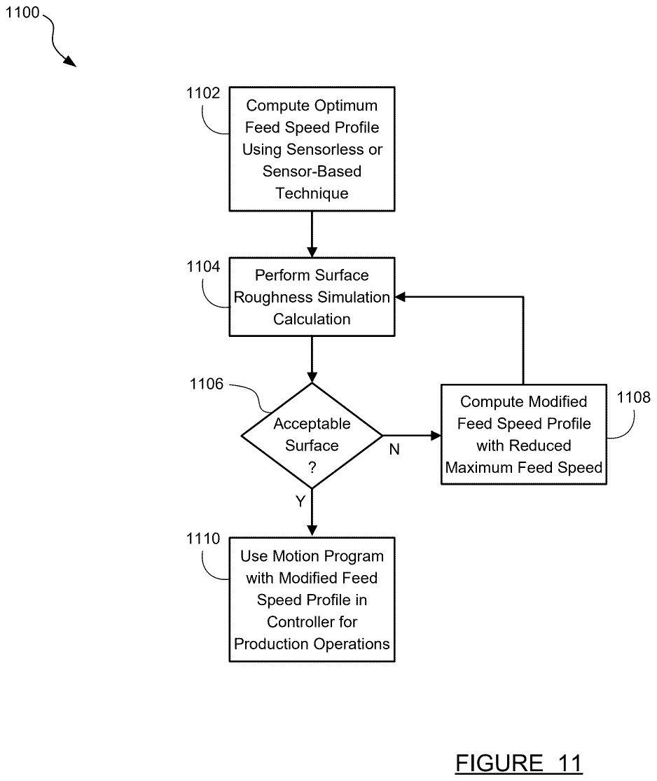

FIG. 11 is a flowchart diagram 1100 of a method for calculating a machining feed speed profile, including first performing a sensorless or sensor-based feed speed optimization, followed by an evaluation of surface roughness and adjustment of the feed speed profile if necessary, according to an embodiment of the present disclosure.

At box 1102, an optimum feed speed profile is computed, using either of the sensorless or sensor-based feed speed optimization techniques discussed in detail above. As described earlier, this results in a feed speed profile where, at each tool center point position along the tool path, an optimum feed speed is defined. In many cases, the optimum feed speed profile includes feed speeds which are greater than those in an original (e.g., constant speed) profile.

At box 1104, a surface roughness prediction simulation is performed using the technique depicted in FIG. 10 and discussed above. That is, at least the fastest feed speed in the optimum feed speed profile is identified, and the surface roughness prediction is performed using that fastest feed speed and the other relevant machining parameters (e.g., spindle speed, tool diameter, etc.). At decision diamond 1106, it is determined whether the surface roughness predicted in the box 1104 is acceptable. This may be done by a human evaluating the roughness prediction, or may be done programmatically by comparing the predicted roughness to a threshold or specification value.

If the predicted surface roughness is not acceptable, then the process moves from the decision diamond 1106 to a box 1108 where a modified feed speed profile is computed. This involves reducing the portions of the feed speed profile with the highest feed speeds. The amount of reduction may be determined in any suitable manner-such as by a fixed percentage (e.g., 5%), or by a percentage selected based on a required reduction in the surface roughness metric. Smoothing or blending techniques may be used to blend the feed speed changes in portions of the profile where the speed is truncated to a new maximum value. The result of the box 1108 is a modified feed speed profile wherein the maximum feed speed is lower than it was in the optimum feed speed profile from the box 1102.

The process returns to the box 1104 to perform the surface roughness prediction using the modified feed speed profile. At the decision diamond 1106, it is again determined whether the surface roughness (now based on the modified feed speed profile) is acceptable. If not, then at the box 1108 another modified feed speed profile is computed with the maximum feed speed further reduced. Looping through the boxes 1108 and 1104 may be repeated more than once in order to achieve the desired surface roughness metric. When the predicted surface roughness is acceptable at the decision diamond 1106, the process moves to box 1110 where the motion program with the final modified feed speed profile is used by the machine controller for actual workpiece machining operations.

Techniques are disclosed above for machining feed speed optimization using sensorless and sensor-based methods, and for evaluating workpiece surface roughness of an optimized feed speed profile before implementing it for production operations. All of these computations and evaluations can be advantageously incorporated into a software application having a graphical user interface (GUI) which leads a user through the setup of the machining operation.

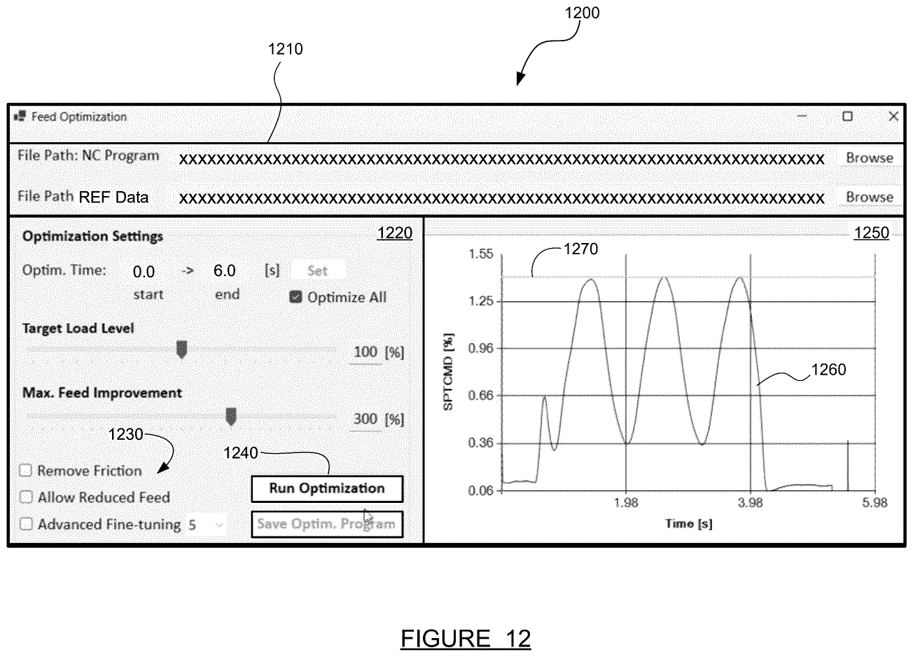

FIG. 12 is an illustration of a graphical user interface (GUI) screen 1200 of a software application configured for performing feed speed optimization of a machining operation, according to embodiments of the present disclosure. The GUI screen 1200 is designed to lead a user through the process of feed speed optimization in a highly automated fashion.

At the top of the GUI screen 1200 in a section 1210, the user selects two input files. The first input file contains the NC program which defines the motions for machining the workpiece/part. The second input file contains the data from the reference machining cycle described earlier—that is, the tool position and motor torque data (for the sensorless embodiment) collected from the reference machining cycle and used to compute the optimal feed speed profile.

Optimization setting and configuration options are defined in a section 1220 at the left of the screen 1200. The settings include defining a time range for the optimization to be performed upon, which may typically be the entire machining cycle. The settings also include selecting the target load level—that is, the percent of the defined maximum machine torque to use for scaling the optimal feed speed profile, as discussed earlier. The target load level may be set to a default value of 100%, but may also be set higher or lower, where a lower target may be selected for tool life extension reasons, for example.

The maximum feed speed increase or improvement is also selectable by a slider bar in the section 1220. The selection of maximum feed speed increase (e.g., to 3 times the constant feed speed used in the machining program) was also discussed earlier. At the lower left, indicated at 1230, are a set of checkboxes for defining other configuration settings. The first two-removing friction torque during the feed speed optimization computation, and allowing feed speed reductions along with increases-were discussed earlier. Another option-labeled “Advanced Fine-tuning”, is for a feature which will be discussed in connection with a later figure.

After the configuration settings are defined as desired, the user can click a Run Optimization button 1240 to run the feed speed optimization computation. At the right of the GUI screen 1200 is a graph section 1250. Before the button 1240 is clicked to run the feed speed optimization, the graph section 1250 contains a graph displaying the spindle torque data from the reference machining cycle in a curve 1260 and the target spindle torque in a line 1270. The Y-axis is labeled on the left with units of percentage of maximum spindle torque.

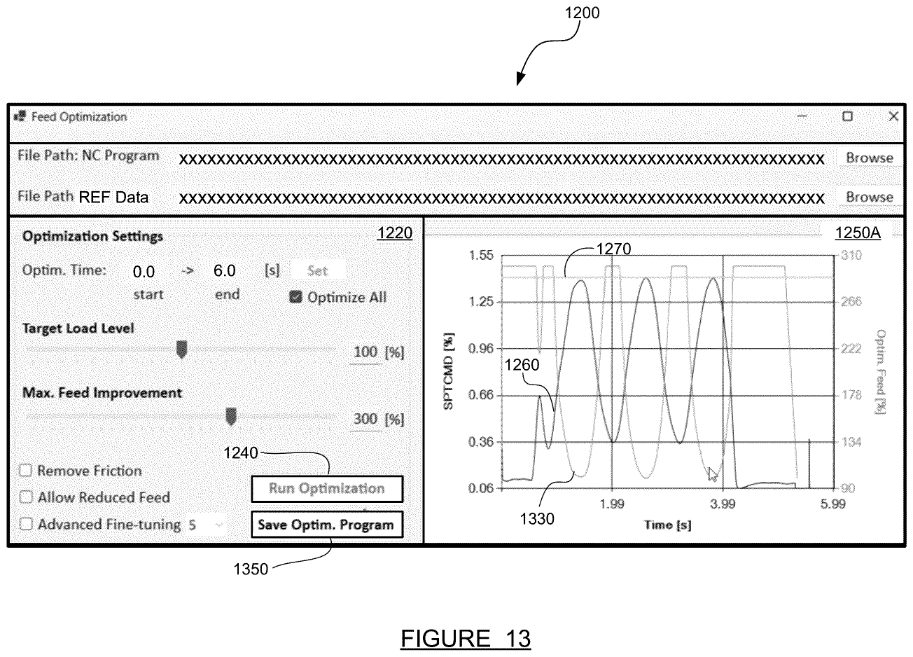

FIG. 13 is an illustration of the graphical user interface (GUI) screen 1200 of FIG. 12, after the feed speed optimization computation has been performed, according to embodiments of the present disclosure. When the user clicks the Run Optimization button 1240 as described above, the software application run the feed speed optimization computation and displays the results (the computation is performed almost instantaneously). At this point, the graph section 1250 is reformatted as a graph section 1250A, where the graph still contains the spindle torque data from the reference machining cycle in the curve 1260 and the target spindle torque in the line 1270, and now further includes a feed speed curve 1330. The feed speed curve 1330 plots the optimal feed speed as a percentage of the original constant feed speed, as indicated by the Y-axis label added to the right. It can be seen that the feed speed curve 1330 is higher where the reference machining cycle spindle torque is lower, and vice versa. This is the effect shown on earlier figures and described in detail above.

After the feed speed optimization computation has been performed, a Save Program button 1350 becomes active, allowing the user to save a new machining program containing the optimized feed speed profile. The new machining program is then available to be used for production machining operations. If the user wishes to try additional configuration settings, the buttons and other controls in the section 1220 may be adjusted, at which point the Run Optimization button 1240 again becomes active.

The software application and the GUI screen 1200 described above are particularly configured for performing feed speed optimization of a machining operation using the sensorless technique based on spindle torque data for a reference machining cycle. The same application and a similar GUI screen can be provided for performing feed speed optimization of a machining operation using the sensor-based technique which uses vibration data for a reference machining cycle.

Another feature of the disclosed feed speed optimization techniques is related to the checkbox for Advanced Fine-tuning shown at the bottom left of FIG. 12 and mentioned briefly above. This feature enables a computation which not only optimizes feed speed for a given machining program, but also add new command lines to the program for finer feed speed tuning. This feature is discussed below.

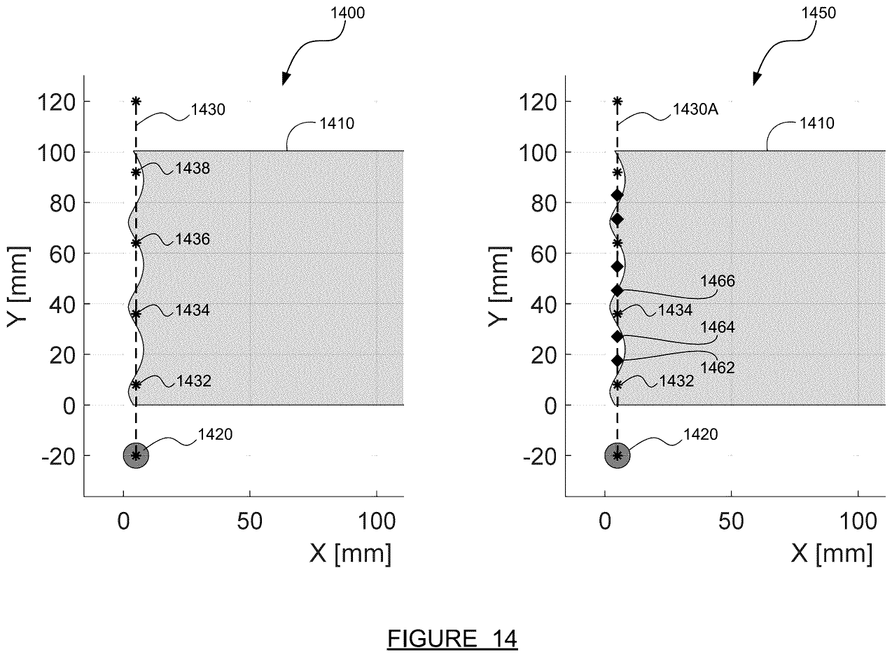

FIG. 14 is an illustration of a workpiece to be machined by a tool path defined by a program containing command lines with a sparse control point spacing, and the workpiece with the tool path redefined with increased control point density, according to embodiments of the present disclosure.

In an illustration 1400 at left, a workpiece 1410 has a wavy shape along its left edge as shown. The workpiece 1410 is to be machined to have a flat surface along its left edge, by a cutting tool 1420 following a tool path 1430 (the dashed line). The tool path 1430 is defined in a machining program by a set of command line control points 1432, 1434, 1436, 1438, etc., which are adequate for defining the tool path (which is a straight line in this case), but are fairly sparsely spaced. In the machining program, a unique feed speed can be defined for the command line containing each control point. However, when the feed speed optimization calculation is performed on the tool path 1430, little feed speed improvement is realized. This is because each of the tool path segments (e.g., from control point 1432 to control point 1434) contains some sections of high material removal rate and some sections of low (or zero) material removal rate, and each tool path segment can only use a single feed speed.

The solution to the problem described above is shown in an illustration 1450 at right. The workpiece 1410 is the same as discussed above. However, using the techniques of the present disclosure, a new machining program is defined which contains additional command line control points, allowing much better application of the feed speed optimization calculations. The cutting tool 1420 follows a tool path now identified as 1430A, because it follows the same trajectory as the tool path 1430 but is defined by a different set of command line control points. In addition to the original control points 1432, 1434, etc., the tool path 1430A also includes added control points 1462, 1464, 1466, etc. Now, when the feed speed optimization calculations are performed on the tool path 1430A, the feed speed can be much better tuned to the actual cutting conditions in tool path each section. For example, the tool path section from the control point 1462 to 1464 is cutting little or no material from the workpiece 1410, so the feed speed can be set to the maximum. Conversely, the tool path section from the control point 1434 to 1466 has a high material removal, and the feed speed will be left near the original feed speed in order to avoid exceeding the target spindle load.

The capabilities described above in connection with FIG. 14—adding command lines to a machining program with finer control point spacing and optimizing the feed speed in the new machining program—are provided using the Advanced Fine-tuning checkbox shown in FIGS. 12 and 13. When that box is checked, the user enters a number of control points to add to the machining program. After running the feed speed optimization using a first number of additional control points, the user can increase the number of additional control points if desired and re-run the optimization computation until obtaining suitable results. The fine-tuning of control point spacing can also be automated as well. For example, when Advanced Fine-tuning is selected, the program can automatically insert an additional command point if the spindle load fluctuates by a prescribed percentage between existing command points, and/or if the optimal feed speed changes by a prescribed percentage between the command points. This control point spacing feature is configurable in the programming of the GUI and its underlying algorithm, and/or by user-entered parameters.

In other embodiments, the surface roughness prediction calculation and the flowchart of FIG. 11 can be added to the software application, in order to provide all of the capabilities to the user in a single interface. This is discussed below.

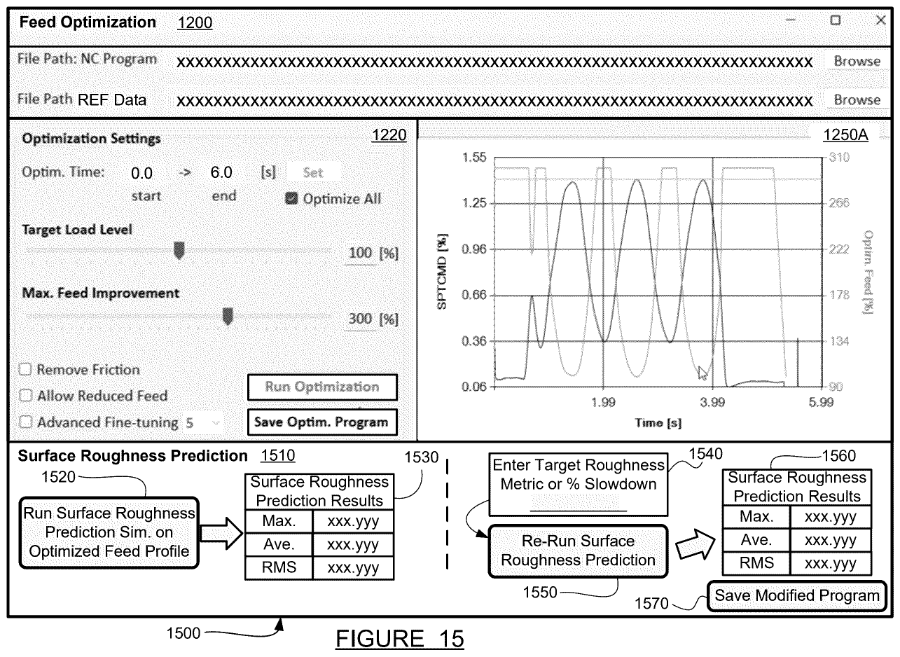

FIG. 15 is an illustration of a GUI screen 1500 of a software application configured for performing feed speed optimization and surface roughness prediction for a machining operation, according to embodiments of the present disclosure. The GUI screen 1500 includes all of the features of the feed speed optimization GUI screen 1200 discussed earlier, including the configuration settings section 1220 and the graph section 1250A. In addition, the GUI screen 1500 includes a surface roughness prediction section 1510 where the user can view the surface roughness prediction results for the optimized feed speed profile and modify the feed speed profile if so desired in order to obtain workpiece surface roughness characteristics which meet requirements.

After performing the feed speed optimization and viewing the results in the sections 1220 and 1250A, the user may perform a surface roughness prediction simulation on the optimized feed speed profile by clicking a button 1520. The results of this surface roughness prediction simulation are displayed in a table 1530, including various surface roughness metrics-such as a maximum, an average and an RMS surface roughness in one non-limiting embodiment.

If the user wishes to improve the surface roughness from the optimized feed profile, this can be done to the right of the section 1510. In a box 1540, the user can enter a target surface roughness metric, or alternately, a percentage slowdown of the highest feed speeds in the optimized profile. Either way, when the user clicks a button 1550, the steps of the FIG. 11 flowchart diagram are performed by the software application, computing a new feed speed profile with a lower maximum feed speed (for example, less than the 300% speed-up mentioned earlier in discussion of FIG. 12), and simulating the surface roughness for the new feed speed profile. The surface roughness prediction results for the modified feed speed profile are displayed in a table 1560. When the user is satisfied with the results, the machining program with the modified feed speed profile can be saved by clicking a button 1570.

The software application with the GUI screen 1500 provides users with all of the capabilities of the presently disclosed feed speed optimization techniques—including feed speed optimization for both sensorless and sensor-based use cases, flexibility in defining the amount of feed speed improvement, convenient configuration option setting, the ability to add command line control points to a machining program in order to better optimize speeds in local sections of the machining operation, and integrated surface roughness prediction with its own configurability and goal matching. Motion profiles optimized using these capabilities can dramatically improve the efficiency of machine tool operations.

Throughout the preceding discussion, various computers and controllers are described and implied. It is to be understood that the software applications and modules of these computers and controllers are executed on one or more electronic computing devices having a processor and a memory module. In particular, this includes the machine controller 140 of FIG. 1 and the controller 410 of FIG. 4. Some or all of the feed speed optimization calculations and surface roughness prediction may also be performed by a separate computing device in communication with the machine controller. Specifically, the processors in the controllers 140/410 and separate computing device are configured to perform the sensorless and/or sensor-based feed speed optimization described above, including the method steps of FIGS. 5, 7 and/or 11, and the calculations using Equations (1)-(6) and other techniques described above, execution of the software application and the GUI of FIGS. 12, 13 and 15, along with the control of the machine tool itself.

While a number of exemplary aspects and embodiments of the methods for sensorless and sensor-based feed speed optimization have been discussed above, those of skill in the art will recognize modifications, permutations, additions and sub-combinations thereof. It is therefore intended that the following appended claims and claims hereafter introduced are interpreted to include all such modifications, permutations, additions and sub-combinations as are within their true spirit and scope.

What is claimed is:

1. A method for sensorless feed speed optimization, said method comprising:
collecting time-series data, by a machine controller, for a reference machining cycle performed by a machine tool, where the data includes a tool center point position along a tool path and a spindle torque command for a plurality of time steps;
determining a spindle torque command target value;
computing an optimum feed speed profile including, for each time step in the time-series data, computing a new feed speed as an original feed speed from the reference machining cycle multiplied by a ratio of the spindle torque command target value to the spindle torque command for the time step, and pairing the new feed speed with the tool center point position in the optimum feed speed profile; and
using a motion program created with the optimum feed speed profile, by the machine controller, to control the machine tool performing production machining operations.

2. The method according to claim 1 wherein the spindle torque command recorded in the reference machining cycle has a value which is computed by the machine controller to cause a spindle of the machine tool to maintain a prescribed rotational velocity.

3. The method according to claim 1 wherein determining a spindle torque command target value includes selecting a maximum spindle torque command value from the reference machining cycle or selecting a spindle torque command value based on limits of the machine tool.

4. The method according to claim 1 wherein the reference machining cycle is performed using a predefined motion program including a constant feed speed.

5. The method according to claim 1 wherein computing a new feed speed includes bounding the new feed speed by a maximum increase factor and a maximum decrease factor relative to the original feed speed.

6. The method according to claim 1 wherein the motion program is created by pairing each tool center point position in the optimum feed speed profile with its corresponding new feed speed, and defining machine tool motion commands including all of the pairings.

7. The method according to claim 1 wherein an air-cut torque value is subtracted from the spindle torque command target value, and from the spindle torque command in the time-series data for the reference machining cycle, before computing the optimum feed speed profile.

8. The method according to claim 1 further comprising using a feedback control algorithm, along with the optimum feed speed profile, by the machine controller to control the machine tool performing the production machining operations.

9. The method according to claim 8 wherein, for each step in the motion program, an optimum feed speed is determined based on tool center point position, the feedback control algorithm calculates an adjusted feed speed from the optimum feed speed and a difference between a reference torque command and an actual torque command from a previous step, and the adjusted feed speed and a new torque command are provided to the machine tool.

10. The method according to claim 8 wherein the feedback control algorithm uses proportional-integral-derivative control.

11. The method according to claim 1 further comprising performing a workpiece surface roughness prediction simulation using feed speed data in the optimum feed speed profile, along with a spindle speed and a radius and number of flutes of a cutting tool.

12. The method according to claim 11 wherein the workpiece surface roughness prediction simulation calculates a shape of a machined surface of the workpiece based on a distance which the cutting tool travels in a feed direction between cuts of one of the flutes of the cutting tool.

13. The method according to claim 1 further comprising using a software application having a graphical user interface (GUI) with which a user defines configuration settings for the feed speed optimization and views graphical results of the feed speed optimization.

14. The method according to claim 13 wherein the GUI and the software application include a user-selectable option wherein a number of additional command line control points are added to the motion program and the optimum feed speed profile is computed for the motion program with the additional command line control points.

15. The method according to claim 13 wherein the GUI and the software application include a surface roughness prediction simulation performed on the optimum feed speed profile, including a computation of a modified feed speed profile meeting a user-defined surface roughness specification.

16. The method according to claim 1 wherein the machine tool is a multi-axis machine tool or an industrial robot with a machining tool head fitted as an end-of-arm tool.

17. A method for sensorless feed speed optimization, said method comprising:
collecting time-series data, by a machine controller, for a reference machining cycle performed by a machine tool, where the data includes a tool center point position along a tool path and a spindle torque command for a plurality of time steps, and where the spindle torque command has a value which is computed by the machine controller to cause a spindle of the machine tool to maintain a prescribed rotational velocity;
determining a spindle torque command target value;
subtracting an air-cut torque value from the spindle torque command target value and from the spindle torque command in the time-series data for the reference machining cycle;
computing an optimum feed speed profile including, for each time step in the time-series data, computing a new feed speed as an original feed speed from the reference machining cycle multiplied by a ratio of the spindle torque command target value to the spindle torque command for the time step, and pairing the new feed speed with the tool center point position in the optimum feed speed profile; and
using a motion program created with the optimum feed speed profile and a feedback control algorithm, by the machine controller, to control the machine tool performing production machining operations.

18. A sensorless machine tool feed speed optimization system, said system comprising:
a machine tool configured for performing an operation on a workpiece; and
a computing device in communication with the machine tool, said computing device being configured to compute and use an optimum feed speed profile by performing steps including;
collecting time-series data for a reference machining cycle performed by the machine tool, where the data includes a tool center point position along a tool path and a spindle torque command for a plurality of time steps;
determining a spindle torque command target value;
computing an optimum feed speed profile including, for each time step in the time-series data, computing a new feed speed as an original feed speed from the reference machining cycle multiplied by a ratio of the spindle torque command target value to the spindle torque command for the time step, and pairing the new feed speed with the tool center point position in the optimum feed speed profile; and
using a motion program created with the optimum feed speed profile to control the machine tool performing production machining operations.

19. The system according to claim 18 wherein the spindle torque command recorded in the reference machining cycle has a value which is computed by the computing device to cause a spindle of the machine tool to maintain a prescribed rotational velocity, and where an air-cut torque value is subtracted from the spindle torque command target value, and from the spindle torque command in the time-series data for the reference machining cycle, before computing the optimum feed speed profile.

20. The system according to claim 18 wherein determining a spindle torque command target value includes selecting a maximum spindle torque command value from the reference machining cycle or selecting a spindle torque command value based on limits of the machine tool.

21. The system according to claim 18 wherein computing a new feed speed includes bounding the new feed speed by a maximum increase factor and a maximum decrease factor relative to the original feed speed.

22. The system according to claim 18 wherein the motion program is created by pairing each tool center point position in the optimum feed speed profile with its corresponding new feed speed, and defining machine tool motion commands including all of the pairings.

23. The system according to claim 18 further comprising using a feedback control algorithm, along with the optimum feed speed profile, by the computing device to control the machine tool performing the production machining operations.

24. The system according to claim 23 wherein, for each step in the motion program, an optimum feed speed is determined based on tool center point position, the feedback control algorithm calculates an adjusted feed speed from the optimum feed speed and a difference between a reference torque command and an actual torque command from a previous step, and the adjusted feed speed and a new torque command are provided to the machine tool.

25. The system according to claim 18 wherein the computing device is further configured to perform a workpiece surface roughness prediction simulation using feed speed data in the optimum feed speed profile, along with a spindle speed and a radius and number of flutes of a cutting tool.

26. The system according to claim 25 wherein the workpiece surface roughness prediction simulation calculates a shape of a machined surface of the workpiece based on a distance which the cutting tool travels in a feed direction between cuts of one of the flutes of the cutting tool.

27. The system according to claim 18 wherein the computing device executes a software application having a graphical user interface (GUI) with which a user defines configuration settings for the feed speed optimization and views graphical results of the feed speed optimization.

28. The system according to claim 27 wherein the GUI and the software application include a user-selectable option wherein a number of additional command line control points are added to the motion program and the optimum feed speed profile is computed for the motion program with the additional command line control points.

29. The system according to claim 27 wherein the GUI and the software application include a surface roughness prediction simulation performed on the optimum feed speed profile, including a computation of a modified feed speed profile meeting a user-defined surface roughness specification.

30. The system according to claim 18 wherein the machine tool is a multi-axis machine tool or an industrial robot with a machining tool head fitted as an end-of-arm tool.
